(19) United States
(12) Patent Application Publication
(10) Pub. No.: US 2010/0169226 A1
(43) Pub. Date: Jul. 1, 2010

(54) METHOD FOR FACILITATING THE OUTSOURCING OF TECHNOLOGY SERVICES

(76) Inventors: Gregg John Lymbery, Wellington (NZ); Stephen M. Pratt, Wellington (NZ); Peter John Cook, Wellington (NZ)

Correspondence Address: UNISYS CORPORATION, UNISYS WAY, MAIL STATION: E8-114, BLUE BELL, PA, 19424, US

(21) Appl. No.: 12/303,993

(22) PCT Filed: Jun. 30, 2006
(86) PCT No.: PCT/US06/25686

§ 371 Date: Dec. 9, 2008

(51) Int. Cl. G06Q 10/00; G06Q 30/00; G06Q 50/00; G06F 3/048

(52) U.S. Cl. 705/80; 705/27; 715/780

(57) ABSTRACT

The invention relates to an improved method of developing and monitoring performance of a technology outsourcing agreement. The invention provides a computer-implemented method of outsourcing technology services to a client where a client has a number of environments in which technology services are required. The method includes selecting the services which are required by the client and displaying a table where each intersection in the table is associated with a service and an environment. In each intersection is an indication of a supplier responsible for the associated service in the associated environment. Each intersection may also be associated with free-form textual information relating to the associated service in the associated environment.

### CROSS REFERENCE TO RELATED APPLICATIONS

The present application claims the benefit of the following PCT Applications: PCT Application Number: PCT/US2006-025685 entitled, “A Method for Outsourcing Technology Services”, PCT/US2006-025678, entitled “A System for Assisting the Generation of an Agreement for Outsourcing Technology Service”; PCT/US2006-025677, entitled “A System for Outsourcing Technology Services” and PCT/US2006-025686, entitled “A Method for Facilitating the Outsourcing of Technology Services”. The subject matter of each of which is incorporated by reference herein.

### FIELD OF INVENTION

The present invention relates to a method for outsourcing technology services. More particularly, but not exclusively, the present invention relates to a computer implemented method of defining responsibility for services to be provided to a client.

### BACKGROUND TO THE INVENTION

In order to reduce costs, organisations (clients) often outsource to another party (the outsourcer) technology required in the organisation. In such instances, the client generally enters into an agreement with the outsourcer in order to ensure that the technology and services to be provided are provided adequately and that there is a legally binding agreement for the provision of the outsourced services. It will be appreciated that the provision of some technology services, such as information technology services, involves a very great number of interrelated services. Consequently, reaching an agreement about the services to be provided by an outsourcer for a client can be an exceedingly complex process.

Conventional methods for entering into an outsourcing agreement include a standardised agreement, provided by the outsourcer, which is then modified to suit the requirements of the client. Alternatively, a new agreement may be created. In addition, the resultant agreement must be monitored in order to ensure that the agreed services are provided in accordance with the agreement and to ensure that the agreed services adequately meet the needs of the client.

There are several difficulties encountered when outsourcing technology. For example, it is difficult to maintain standardisation within the agreement between the client and the outsourcer while providing a client-centric approach to providing services (i.e. a customised approach). In addition, it is difficult to ascertain precise terms of the agreement, often because the agreement has not been captured adequately. Much of this is further complicated by the fact that traditional agreements are difficult to negotiate and modify as they are structured in view of the way they are negotiated and the number of people and functional groups involved. It is also difficult to add customised information to such agreements, since they may be lengthy and additions of information must be made manually. This may result in additions being made at inappropriate places in the contract and requires significant user effort and time.

Existing methods provide neither a structured approach to outsourcing negotiations nor do they provide for a structured approach to modifying an agreement based on monitoring of the delivery of the services agreed on. The result of existing methods of outsourcing is often an inconsistent definition of the outsourcing agreement and service demarcation because these methods are based on delivery experience rather than contract generation. In addition, there are few adequate methods of monitoring the resultant outsourcing agreement to ensure that the services are provided in accordance with the agreement and to monitor to ensure that the services contracted are adequate.

Therefore, it is an object of the present invention to overcome the above disadvantages of existing methods of technology outsourcing by providing a more effective method and system for outsourcing technology services, or to at least provide the public with a useful choice.

### SUMMARY OF THE INVENTION

In a first aspect the invention provides a computer-implemented method of outsourcing a plurality of technology services to a client within a plurality of environments, including the steps of:
a. selecting the plurality of services required by the client from a fixed list of services;
b. displaying on a graphical user interface a table,
   each intersection in the table being associated with a service and an environment and indicating a supplier for the associated service in the associated environment, each supplier being selected from the set of an outsourcer, the client, and a third party; and
c. receiving further information from a user using a free-form text input, wherein at least one intersection in the table is also associated with such further information relating to the associated service in the associated environment.

The further information preferably relates to any one of inclusions, volumes, locations, versions, and exclusions.

Preferably each supplier is associated with a visual indicator and the supplier is indicated within the table using the visual indicator. Each visual indicator may be a colour.

The method preferably also includes the step of generating an agreement according to the selected services, suppliers and further information. The services are preferably information technology services.

The fixed list of services is preferably displayed on the graphical user interface and is ordered by group, each group including services selected from: account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, internet services, application support capacity planning, architecture, consulting services & supplementary services, data management, network management, and system management.

This first aspect of the invention also extends to a computer programmed to operate in accordance with the method of the invention.

In a second aspect the invention provides a computer-readable medium having stored thereon a computer program comprising instructions which, when executed by a computer, cause the computer to perform the steps of:
a. selecting the plurality of services required by the client from a fixed list of services;
b. displaying on the graphical user interface a table indicating a supplier for each selected service in each environment of the client,
   each supplier being selected from the set of an outsourcer, the client, and a third party, and
   each intersection in the table being associated with a service and an environment and indicating a supplier for the associated service in the associated environment; and
c. receiving further information from a user using a free-form text input, wherein at least one intersection in the table is also associated with such further information relating to the associated service in the associated environment.

### BRIEF DESCRIPTION OF THE DRAWINGS

Embodiments of the invention will now be described, by way of example only, with reference to the accompanying drawings in which:

FIG. 1: shows an example of a framework within which the method of the invention may be used;

FIG. 2: shows an example of a list of services from which required services may be selected;

FIG. 3: shows an example of a table allowing selection of suppliers for selected services in each environment, and receipt of further information from a user via a free-form text-input;

FIG. 4: shows an example of an extract of an outsourcing contract; and

FIG. 5: shows one embodiment of a computer system on which the invention may be implemented.

### DETAILED DESCRIPTION OF PREFERRED EMBODIMENTS

The present invention will be described in relation to information technology services outsourcing. However, it will be appreciated that, with modifications, the method may be adapted for use with outsourcing of other technology services.

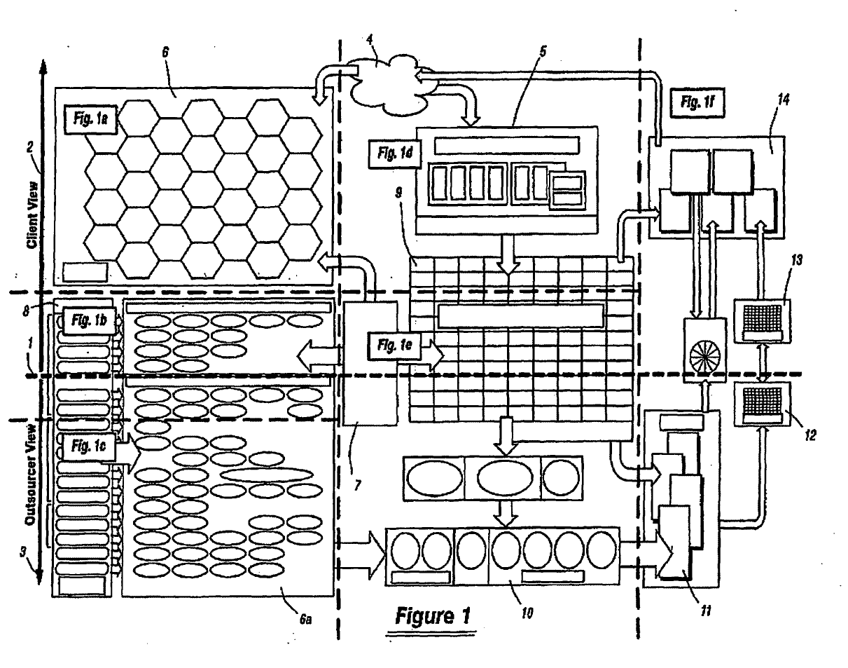

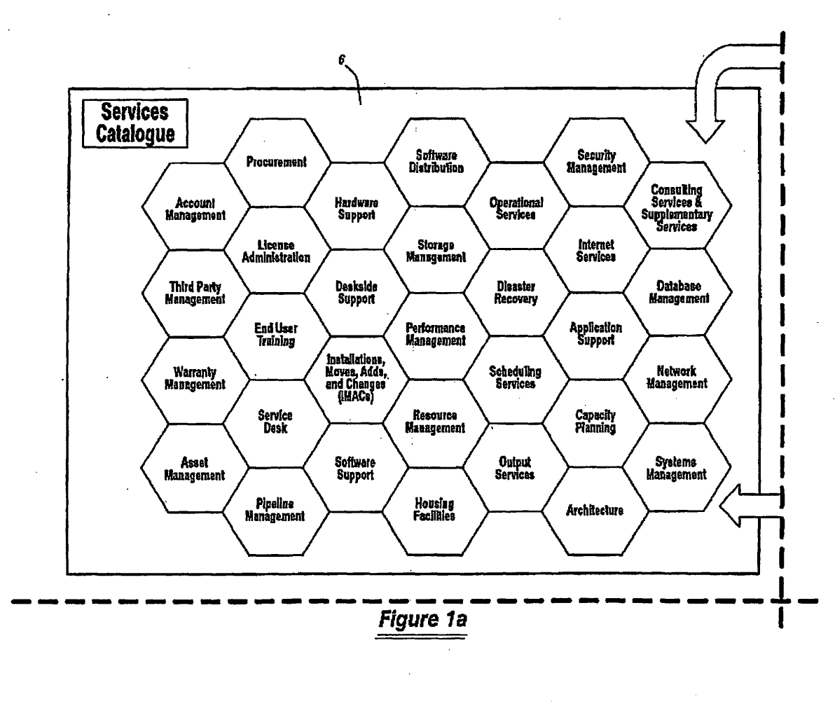

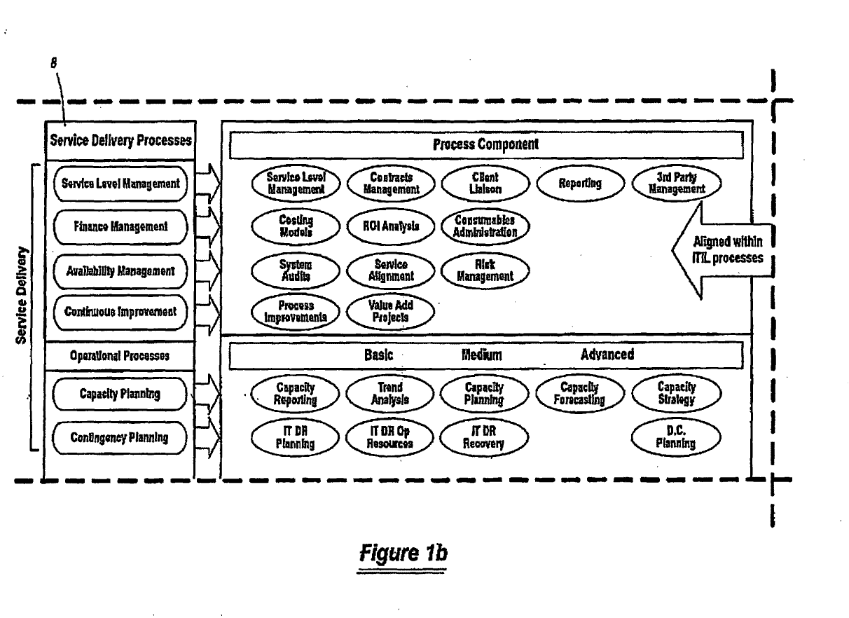

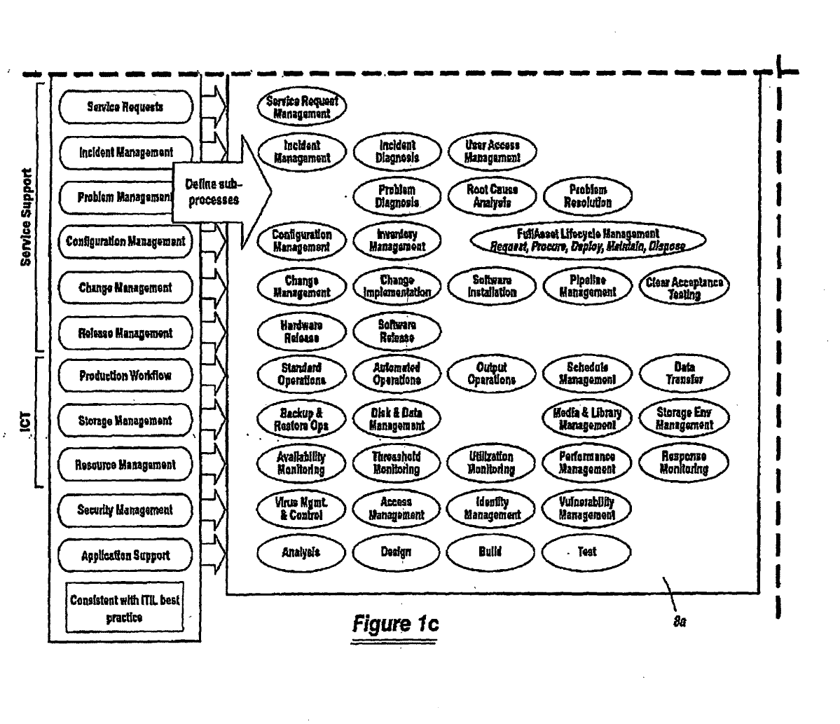

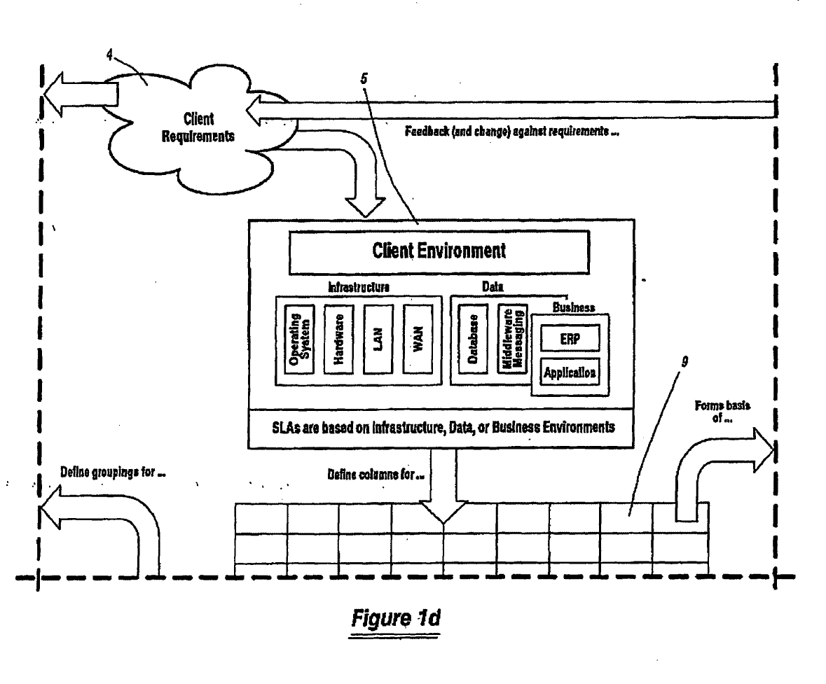

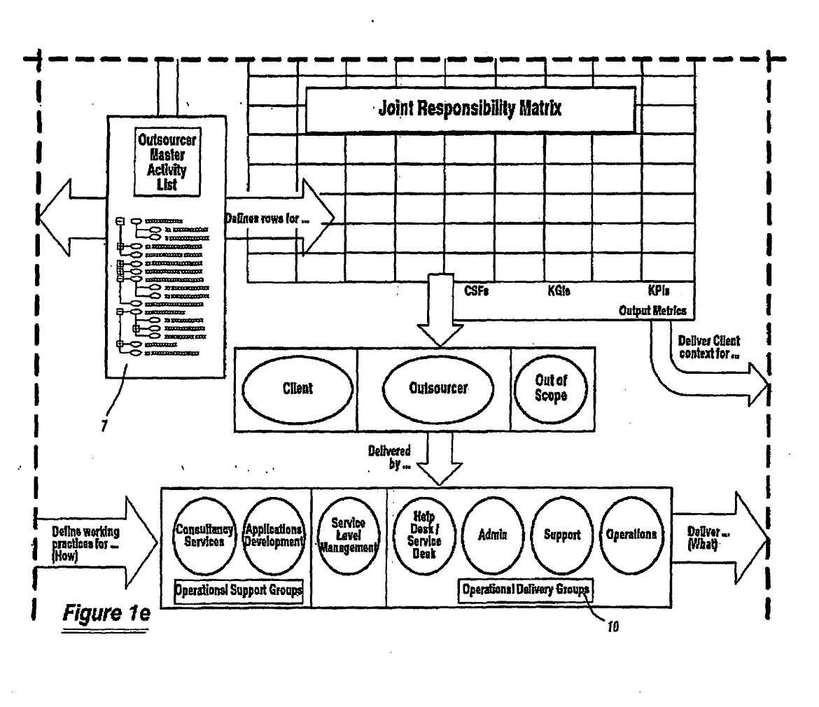

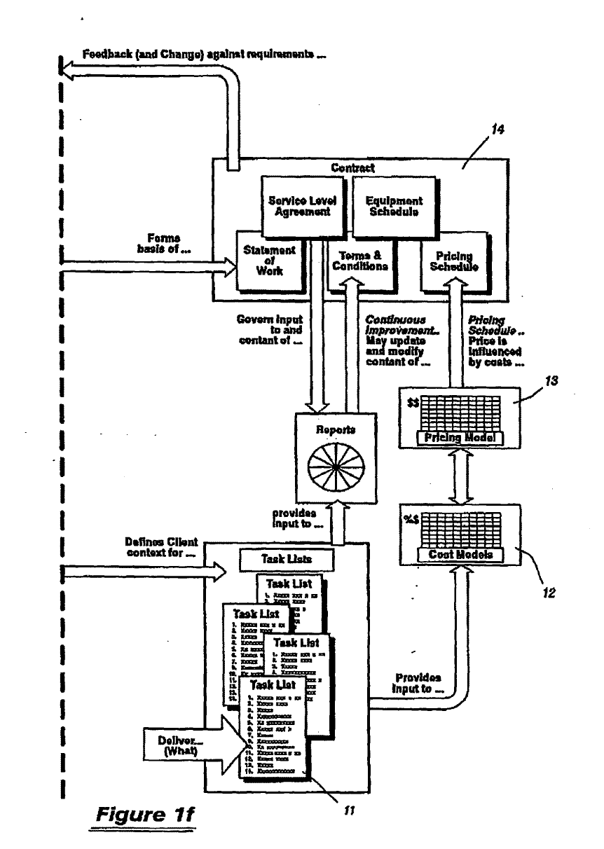

In one embodiment, the method of the invention may be used within a wider framework that facilitates a consistent approach to selling, delivering and monitoring information technology outsourcing services. FIG. 1 shows an example of such a framework. FIGS. 1a, 1b and 1c are as a whole identical to FIG. 1, but show the framework in greater detail.

With reference to FIG. 1 the components of the framework may be horizontally split along dashed fine 1 into two conceptual views. The client focuses on the components shown in the upper level 2. The components in the upper level relate to services required by the client and outcomes the client wants to achieve. The outsourcer focuses on the components shown in the lower level 3. The components in the lower level 3 relate to how the services will be delivered. FIG. 1 illustrates how client requirements may be translated into specific tasks to be performed by the outsourcer. This model provides clients with some visibility of the delivery model for the outsourced services but does not require exploration by the client of the specific tasks or resources required in delivering the services. Some components require input from both the client and the outsourcer, or agreement between the client and the outsourcer, as described below.

According to the framework shown in FIG. 1, client background information and the client's requirements 4 may be gathered from the client. These requirements may be extracted during a consultative process. A full understanding by the outsourcer of the requirements and the client's technology structures assists in understanding the services the client is expecting and the services for which the outsourcer will be responsible.

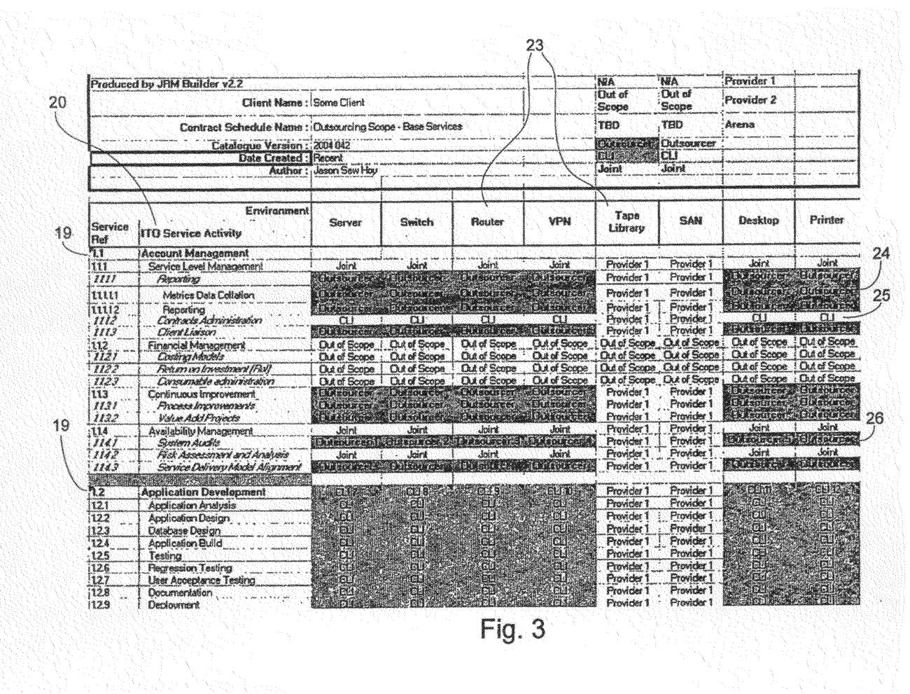

The method may also include definition of the customer environments 5. The customer environments 5 provide the context in which the services are provided. This definition may take a variety of forms depending on the client requirements. For example the environment may be described at a technology level including elements such as servers, printers, routers etc. Such environments might include a server environment and a tape library environment, for example, as shown generally at 23 in FIG. 3. Alternatively the environment may be described at a business systems level including elements such as payroll system, messaging system, application system etc. Such environments might include a payroll environment and an accounts-payable environment, for example. Other environments as known to those of skill may be included, and they are intended to be within the purview of the present invention. From the perspective of the outsourcer, each client environment may require a different combination of services, metrics and service levels appropriate to the technology and appropriate to the way that the services are delivered.

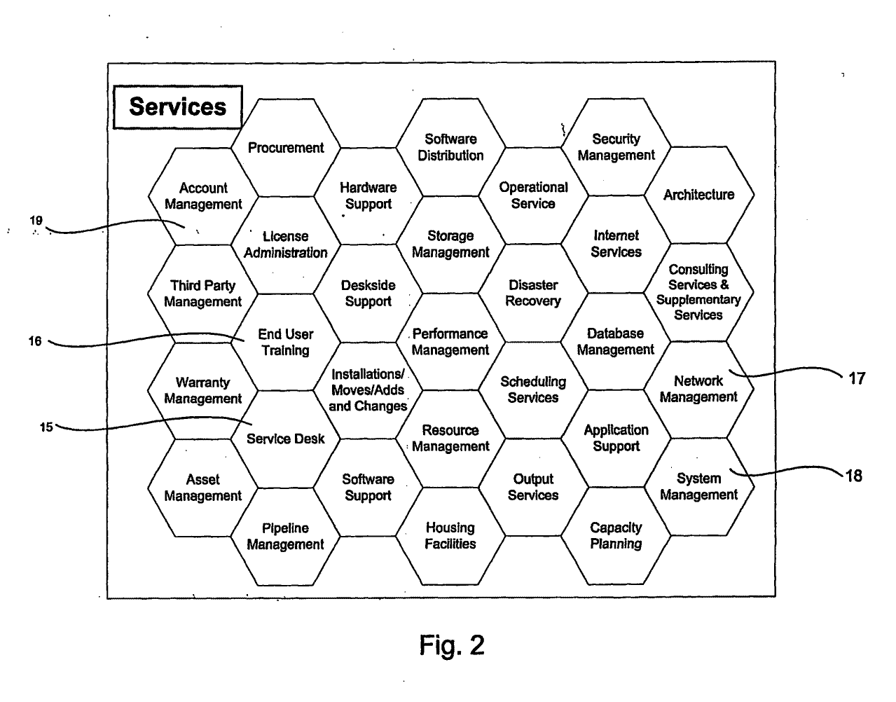

The client requirements 4 may also be used to determine the key services e.g. 15, 16, 17, 18, 19 (FIG. 2) to be provided in each identified environment 5. The key services e.g. 15, 16, 17, 18, 19 may be chosen from a fixed list of available services (for example, the list shown in FIG. 2), where the fixed list is a list which has resulted from a thorough consideration of the issues involved in outsourcing technology and from the extensive experience of outsourcers. The list shows what the outsourcer can deliver to the client and is preferably ordered or arranged in groups based on a functional relationship. For example, “Service Desk” is listed next to “End User Training” because service desk is related to end user training. The list or matrix may also include elements representing collections of services packaged into a well defined portfolio solution, for example, network management, and systems management. The key services shown in FIG. 2 have been developed utilising extensive experience to provide an optimal arrangement of services for an outsourcer to provide to a client. However, it will be appreciated that, although this list of key services is preferred, a modified list of services could be employed.

In a preferred embodiment, the order of all the key services is preferably as follows: account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, Internet services, application support capacity planning, architecture, consulting services & supplementary services, data management, network management, and system management.

In the preferred embodiment the fixed list of available key services is shown as a honeycomb matrix 6, such as that shown in FIG. 2. The honeycomb matrix provides a clear high level menu of key services typically required in an information technology environment. It is also preferred that the list or matrix of key services is displayed on a graphical user interface.

The presentation of an ordered or grouped list or matrix of key services from which the client can select required services has several advantages including, but not limited to: facilitating communication of the available key services to the clients; providing high level key service descriptions to assist in scoping the outsourcing agreement; allowing the value of specific key services to be highlighted and recognised; and allowing indicative pricing to be quickly calculated. The use of this list also ensures that all relevant key services are brought to the attention of the client and/or the outsourcer. It is therefore less likely that the parties will forget a particular key service their attention will necessarily be drawn to each relevant key service.

Each of the key services e.g. 15, 16, 17, 18, 19 can be decomposed into a list of sub-services. In this specification, the term “services” is intended to include key services and sub-services unless the context clearly requires otherwise. The Master Activity List 7, is preferably a complete list of key services and the sub-services that make up the key services e.g. 15, 16, 17, 18, 19 in the identified environment 5. The Master Activity List 7 contains an appropriate level of detail to be used within the Statement of Work contained in the outsourcing agreement, and each sub-service in the Master Activity List 7 is specific to a single key service e.g. 15, 16, 17, 18, 19. The Master Activity List 7 also provides clarification about what aspects of the key service e.g. 15, 16, 17, 18, 19 the client requires. Each sub-service may be further decomposed into another list of services. A hierarchy of several levels of services may thus be created.

The services in the Master Activity List 7 are associated with a set of delivery processes 8. The delivery processes 8 are preferably consistent with Information Technology Infrastructure Library best practices. The ITIL is a well-known framework of supplier-independent best practice approaches for delivery of information technology (IT) services. Consistency with the ITIL therefore ensures that the services performed by the outsourcer comply with recognised information technology best practices.

The Master Activity List 7 may define the rows in a Joint Responsibility Matrix 9, which will be described in detail below, with reference to FIG. 3.

With further reference to FIG. 1, the outsourcer may also have a set of operational delivery groups 10 responsible for delivering specific services. Each service in the Joint Responsibility Matrix 9 may be assigned to the most appropriate delivery group 10. For example, end user training services may be assigned to an operational delivery group devoted to providing end user training services. In this way it can be ensured that what has been requested with regard to services 15, 16, 17, 18, 19 is able to be delivered.

Task lists 11 can set out the detail of the specific tasks required to deliver the services 7 in each environment 5. The tasks are preferably defined to relate to the specific technology used by the client. The tasks are resource driven and may vary by geography and management capability.

The task lists 11 provide input into cost models 12 and pricing models 13. Cost models contain assessments of the cost of delivery of the services based on what the outsourcer knows about the environments. Pricing models 13 contain assessments of the price to be charged for service delivery, based on the output of the cost models 12, scope and volume of services to be provided and the markup (i.e. profit margin) imposed by the outsourcer. The models are based on extensive industry experience. These models 12, 13 form part of the outsourcing contract.

The outsourcing contract 14 is designed to turn the client requirements into contractual documents. The contract 14 preferably contains a Statement of Work which may be a text version of the Joint Responsibility Matrix 9 and records the scope of the services 15, 16, 17, 18 to be provided and clearly defines responsibility for the delivery of each service 7. The Statement of Work may be further modified to clearly document the specific client circumstances and requirements. The contract also preferably includes an equipment schedule that identifies the entire information technology infrastructure that the outsourcer is responsible for at the time of commencement of the contract. Any subsequent variation to this schedule would imply a variation in the service fees payable. The contract also includes a service level agreement which sets out the client's expectations for service delivery using metrics and service levels. These may be aimed at overall business outcomes but may also include specific measurements for a particular service. The outsourcing contract thus produced defines the relationship between the client and the outsourcer. Other contracts or agreements may also be produced between third parties and the client and/or outsourcer.

Returning to FIG. 3, an exemplary Joint Responsibility Matrix 9 is displayed on a graphical user interface. The Joint Responsibility Matrix 9 is a table which allows a user to define the party responsible for providing each service in the Master Activity List 7 in each environment of the client. Thus the Joint Responsibility Matrix 9 provides an easily understandable visual display, so that it is easy to see who is responsible for service-delivery, which services have yet to be assigned to a provider etc. The rows 20 of the Joint Responsibility Matrix 9 are defined by the services in the Master Activity List 7 including the key services e.g. 15, 16, 17, 18, 19 and the sub-services that make up the key services. Each key service 19 is shown as a heading using font variation, justification, and numerals. Underneath each key service 19 are sub-services related to the key service.

The columns 23 in the Joint Responsibility Matrix 9 are defined by the customer environments 5 (FIG. 1). As described above, the environments can be defined by any logical grouping. For example, there may be environments of the client based on geography—“Los Angeles”, “Chicago” and “New York”, or based on business function—“Retail” and “Distribution”, or based on technology—“Servers” and “PCs”. It will be appreciated that a combination of logical groupings may be utilised as well. For example, “Retail Servers”, “Retail PCs”, “Distribution Servers”, and “Distribution PCs”.

Each intersection in the Joint Responsibility Matrix is associated with a particular service in a particular environment, and each contains the responsible party for providing the associated service in the associated environment. The responsible parties can include the outsourcer, the client, and one or more other third party service providers.

Visual indicators may be used to identify the responsible parties. For example, the responsible parties may be colour-coded, such that one responsible party is one colour as in intersection 24 and another responsible party is a second colour as in intersection 25. Although, for reasons of clarity, only two shades of grey are used in the drawings, any number of colours may be used in practice to colour-code a larger number of parties. Alternatively, another form of visual indicator such as a symbol may be used to represent each responsible party. The advantage of this is that it is possible at a glance to ascertain is the party responsible for providing which service, where responsibilities overlap or where responsibility for a service has been overlooked. If the parties are unable to agree on a supplier for a particular service in a particular environment, but wish to return to this at a later stage of the negotiations, a visual indicator may be assigned to that intersection, to remind the parties that they have discussed this point and should return to it.

At least some of the intersections are also associated with information related to the performance of the service for the environment. The information is preferably entered as free-form text by a user. This allows a user to input customised information relating to supply of a particular service in a particular environment. This further information will preferably be included in the final contract or statement of work. The existence of further information associated with the intersection may be indicated by the addition of a reference numeral 26 to the intersection. The reference numeral corresponds to a footnote to the matrix.

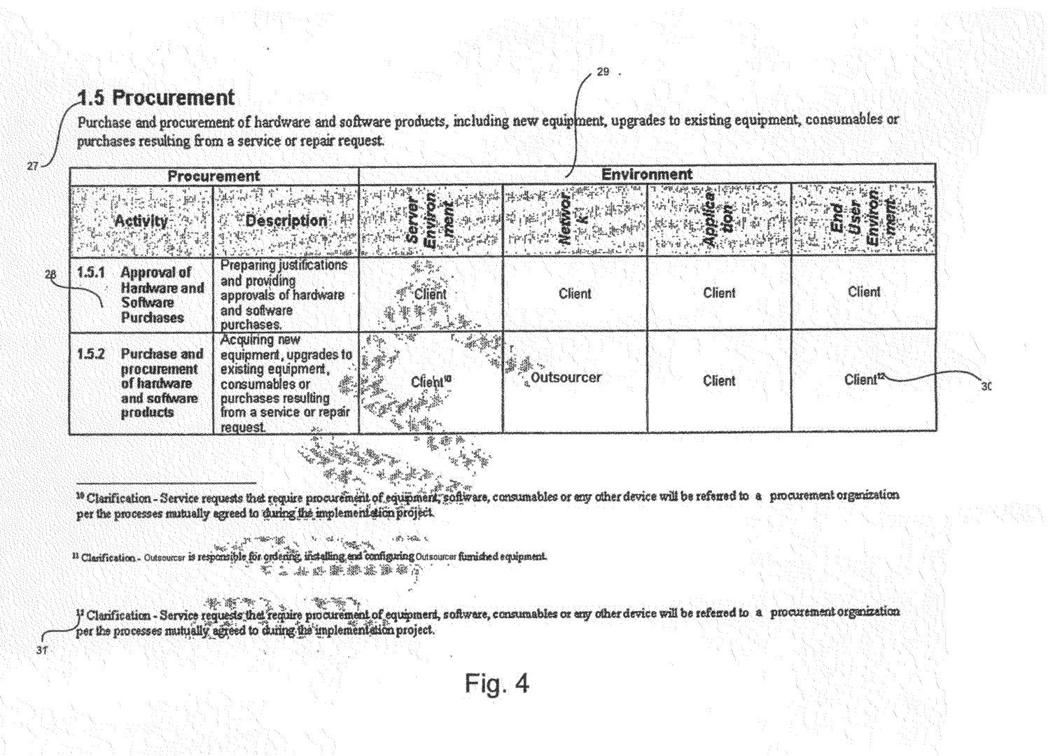

FIG. 4 shows an example of an extract of an agreement developed from the Joint Responsibility Matrix of FIG. 3. The contract schedule extract includes a statement 27 of the key service 15, 16, 17, 18 to which it relates and a description of that service. The schedule also shows the sub-services 28 including their descriptions. The environments 29 in which the services are to be provided are also shown. The party responsible for the provision of each service in each environment is shown in the intersections of the table. The schedule may also include further information relating to the provision of a particular service in a particular environment, in the form of footnotes 31. This information may be associated with a particular intersection by a reference numeral 30. Other methods of showing such information may also be suitable.

The further information can relate to inclusions in the service, volumes, locations, versions, or exclusions from the service. It will be appreciated that the information can also relate to any other modifying criteria. Inclusions and exclusions include modifications to the standard service description to include/exclude some components of the service or include/exclude some elements of the environment (for example, some items of the environment could be excluded to cut cost). Volumes are the number of items in the environment or the number of times that the service is performed. Locations are the locations of the environment components or the locations to which the service will be delivered, which can affect the costs of delivery. Information relating to versions includes different version numbers of software or hardware, which may have different service implications affecting the cost.

The method may be used in conjunction with negotiations between an outsourcer and the client to establish which services are to be provided, who is to provide the services, and to what level (quality) the services are to be provided.

In a preferred embodiment of the invention the framework also includes a module to capture metrics discussed during the negotiations. These metrics will be used to determine which services are to be provided and at what level the services are to be provided, and can relate to any of frequency of delivery; the quality of the service; the availability of components of the environment; and the ability of the environment to support the business. For example, the client and the consultant might determine that a service desk for the client is required to handle 500 phone calls a day. Thus the metric for Service Desk may be 500 calls per day.

Some key metrics that can be used are Critical Success Factor (CSF), Key Goal Indicator (KGI), and/or Key Performance Indicator (KPI). A CSF is an aspect or condition that is required for optimal success or an activity recommend for optimal success. A KGI, representing a process goal, is a measure of what has to be accomplished. It is a measurable indicator of the process achieving its goals, often defined as a target to be achieved. A KPI is a measure of how well the process is performing.

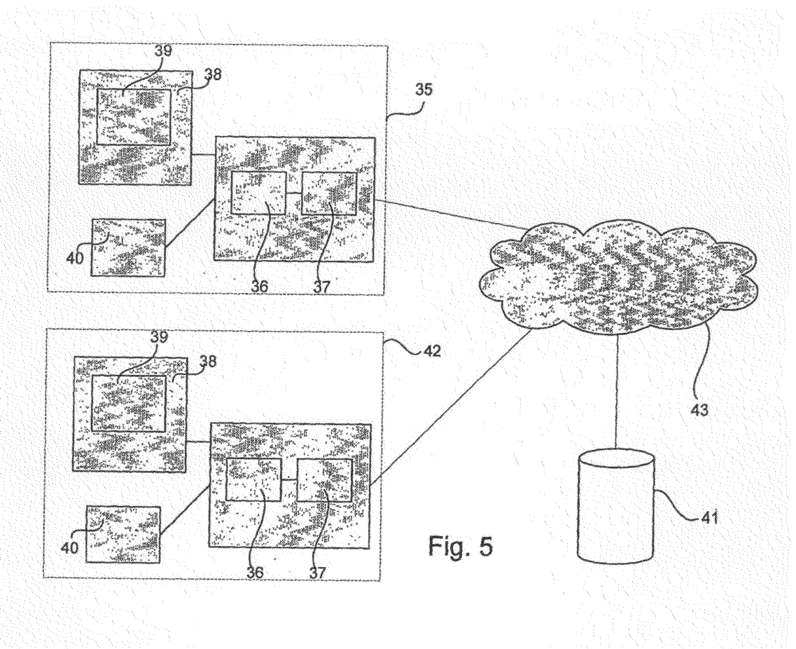

FIG. 5 shows an embodiment of a computer system on which the method may be implemented. The method may simply be executed on a computer 35 including a computer processor 36 and computer memory 37. The computer 35 preferably includes a visual display device 38 capable of displaying a graphical user interface 39. The computer preferably also includes an input device 40 such as a keyboard. Computer software suitable for implementing the method described above may be stored on a suitable medium such as the computer memory 37. Required databases may also be stored in computer memory 37. Of course, such a computer may also communicate with one or more external databases 41 and/or other computers 42 over a network 43 in order to implement the invention. It will be appreciated that the system can be developing using one of any number of programming languages and can be deployed within many hardware configurations.

The method of the invention provides the following advantages:
The graphical presentation of the Matrix makes it is easier to see who is delivering each service, where service delivery is inconsistent or inappropriate within an environment, and where service delivery and the groups providing can be rationalised to help reduce costs.
It is easier to see if all the necessary services have been defined.
It is easier to ensure responsibility for all necessary services has been allocated
It is easier to add current information (delivery performance, improvement initiatives etc) to the contract information.
It is easier to modify as things change and to assess the impact of imminent change.
The scope of responsibility of each party is clearly and accurately captured in the outsourcing agreement.
The invention is able to present all of the services for a contract on a single piece of paper (or a detailed view on a few sheets of A4).
It is easier to identify gaps in the delivery of the services.
A fixed list of services enables all relevant issues to be considered.
It is possible to add further information in a simple manner and to view the services, environments, suppliers and an indication of whether such further information has been added in a single, accessible matrix. This provides an accessible overview of the agreement, reducing error and required time and effort, but providing flexibility in terms of contract content.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A computer-implemented method of outsourcing a plurality of technology services to a client within a plurality of environments, including the steps of:
a. selecting the plurality of services required by the client from a fixed list of services;
b. displaying on a graphical user interface a table,
each intersection in the table being associated with a service and an environment and indicating a supplier for the associated service in the associated environment,
each supplier being selected from the set of an outsourcer, the client, and a third party; and
c. receiving further information from a user using a free-form text input, wherein at least one intersection in the table is also associated with such further information relating to the associated service in the associated environment.

2. The method as claimed in claim 1 wherein the further information relates to any one of inclusions, volumes, locations, versions, and exclusions.

3. The method as claimed in claim 1 wherein each supplier is associated with a visual indicator and the supplier is indicated within the table using the visual indicator

4. The method as claimed in claim 3 wherein each visual indicator is a colour.

5. The method as claimed in claim 1, including the step of generating an agreement according to the selected services, suppliers and further information.

6. The method as claimed in claim 1, wherein the services are information technology services.

7. The method as claimed in claim 1, wherein the fixed list of services is displayed on the graphical user interface.

8. The method of claim 1, wherein the fixed list of services is ordered by group, each group including services selected from: account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, Internet services, application support capacity planning, architecture, consulting services & supplementary services, data management, network management, and system management.

9. A computer-readable medium having stored thereon a computer program comprising instructions which, when executed by a computer, cause the computer to perform the steps of:
a. selecting the plurality of services required by the client from a fixed list of services displayed on a graphical user interface;
b. displaying on the graphical user interface a table indicating a supplier for each selected service in each environment of the client,
each supplier being selected from the set of an outsourcer, the client, and a third party, and
each intersection in the table being associated with a service and an environment and indicating a supplier for the associated service in the associated environment; and
c. receiving further information from a user using a free-form text input, wherein at least one intersection in the table is also associated with such further information relating to the associated service in the associated environment.

10. A computer programmed to operate in accordance with the method of claim 1.
